(19) United States
(12) Patent Application Publication
(10) Pub. No.: US 2010/0027435 A1
(43) Pub. Date: Feb. 4, 2010

(54) WIRELESS SYSTEM DESIGNING METHOD, WIRELESS SYSTEM DESIGNING SYSTEM, WIRELESS SYSTEM DESIGNING APPARATUS AND PROGRAM

(75) Inventor: Wataru Domon, Tokyo (JP)

Correspondence Address: YOUNG & THOMPSON, 209 Madison Street, Suite 500, Alexandria, VA, 22314, US

(73) Assignee: NEC CORPORATION, MINATO-KU (JP)

(21) Appl. No.: 12/515,347

(22) PCT Filed: Oct. 25, 2007
(86) PCT No.: PCT/JP2007/070792

§ 371 Date: May 18, 2009

(30) Foreign Application Priority Data
Nov. 21, 2006 (JP) 2006-313777

(51) Int. Cl. H04L 12/26

(52) U.S. Cl. 370/252

(57) ABSTRACT

In a station placement design of a scheme which assigns an address to each wireless station when a network is configured, the station placement design is enabled to ensure that addresses can be assigned. A wireless system designing method is a wireless system designing method for designing a wireless system having a mode in which an address is assigned to each wireless station when a network is formed, wherein a link quality is estimated between respective wireless stations which are installed within a predetermined region, and it is confirmed whether or not an address can be assigned to each wireless station in a topology which is formed only with links which are estimated to have link qualities equal to or higher than a predetermined level.

### TECHNICAL FIELD

The present invention relates to a wireless system designing method, a wireless system designing system, a wireless system designing apparatus, and a wireless system designing program for designing locations at which wireless stations, which are components of a wireless communication system, are installed.

### BACKGROUND ART

For building a wireless communication system, work called “station placement design” is performed for designing locations at which wireless stations, which are components of the wireless communication system, are installed. In the station placement design, locations at which wireless stations should be installed are determined such that wireless communications can be made over an entire area in which the wireless communication system is desired for utilization.

Patent Document 1 discloses a method and apparatus for estimating the communication quality of an area in which a wireless communication system is desired for utilization, with the intention of performing the station placement design. Patent Document 1 describes a propagation environment notification method for a wireless communication system which allows a user himself to readily know domestic wireless propagation environment information (see FIG. 11 of Patent Document 1). Specifically, received power and delay dispersion at each location are utilized as the communication quality.

Non-Patent Document 1 discloses the specification of the ZigBee standard which is one specification for a wireless communication system. The ZigBee standard is advantageous, for example, in that lower power consumption can be accomplished.

In the following, the ZigBee standard will be described. FIG. 1 is a system configuration diagram showing an example of a wireless communication system which conforms to the ZigBee standard specification. As shown in FIG. 1, in the ZigBee standard, wireless stations which communicate with each other can form a parent-child relationship to configure a tree-shaped wireless network. A parent wireless station positioned at the peak of the tree is referred to as a coordinator (ZigBee Coordinator). Also, a wireless station is referred to as a router when it is a child station for a certain wireless station and is simultaneously a parent station for another wireless station. Each wireless station is not essentially equipped with the functions of the coordinator or router. A wireless station is referred to as an end device when it is not equipped with these functions. Then, these coordinators, routers, and end devices configure a ZigBee network. In this regard, while a parent-child relationship formed between wireless stations is represented by a line segment which connects both parties in FIG. 1, the wireless stations are actually connected through a wireless link.

The ZigBee standard employs a 16-bit address called “short address” which is assigned for communications to each of the wireless stations which form part of a network. Then, the ZigBee standard defines a method of assigning the short address to each wireless station.

Three parameters, a maximum number of child stations (Cm), a maximum number of routers (Rm), and a maximum number of layers (Lm), are used for the assignment of short addresses. Cm indicates an upper limit for the number of child stations which can be connected to a single parent station. Rm represents an upper limit for the number of wireless stations which include the router function among the child stations. Lm in turn indicates an upper limit for the number of wireless links from a coordinator to a wireless station at an extreme end. In other words, communication between a coordinator and an end device can be relayed by a number of routers equal to the value of Lm minus one.

With the use of these values, one can know how many wireless stations a certain wireless station can accommodate. Accordingly, in a general short address assignment method, a wireless station on the same layer as a predetermined wireless station (wireless stations connected to the same parent station as the predetermined wireless station) is assigned a short address which presents a value equal to the number of wireless stations accommodated by the predetermined wireless station plus one.

For example, a specific address assignment method will be described giving the wireless communication system shown in FIG. 1 as an example, where Cm=4, Rm=4, and Lm=3. In this regard, a number written in a square indicative of each wireless station represents a short address in FIG. 1. First, a coordinator is assigned address 0 at any time.

Next, address 1 is assigned to a wireless station which first establishes a parent-child relationship with this coordinator. This wireless station that has been assigned address 1 can accommodate four child stations (Cm=4), and each of these child stations can accommodate four child stations. In other words, the wireless station having address 1 can accommodate 21 wireless stations including itself. Therefore, address 22 is assigned to a wireless station which establishes a parent-child relationship with the coordinator at the second time. Essentially, this processing is performed irrespective of how many wireless stations the wireless station that has address 1 actually accommodates.

Addresses are assigned on each layer through processing similar to the foregoing processing. For example, address 2 is assigned to a wireless station which first establishes a parent-child relationship with the wireless station having address 1. In this event, since this wireless station can accommodate five wireless stations including itself, address 7 is assigned to a wireless station which establishes a parent-child relationship with the wireless station having address 1 at the second time.

### Patent Document 1: JP-2005-102276-A (Paragraphs 0037-0040, FIG. 11)

Non-Patent Document 1: “ZigBee Specification,” ZigBee Document 053474r06, Version 1.0, ZigBee™ Alliance, Jun. 27, 2005, pp. 222-224

### DISCLOSURE OF THE INVENTION

### Problems to be Solved by the Invention

As described above, the ZigBee standard employs three parameters, i.e., the maximum number of child stations (Cm), maximum number of routers (Rm), and maximum number of layers (Lm) to keep track of the number of wireless stations which can be accommodated by each wireless station, and assigns short addresses in accordance therewith. This means that wireless stations may exist beyond the number of wireless stations which can be accommodated, depending on the physical placement of wireless stations, so that some wireless stations cannot be connected to the network.

For example, in FIG. 1, the wireless station having address 2 can accommodate four wireless stations, but when five or more wireless stations exist at locations at which communications can be made only with this wireless station having address 2, one or more wireless stations cannot be connected to the network. Therefore, in the station placement design of a ZigBee system, it is necessary to confirm whether or not the address can be assigned to each wireless station. However, the possibility of address assignment to each wireless station is not referred to in the propagation environment notification method for a wireless communication system described in Patent Document 1.

It is an object of the present invention to provide a wireless system designing method, a wireless system designing system, a wireless system designing apparatus, and a wireless system designing program which are capable of solving the problems mentioned above.

### Means for Solving the Problem

A wireless system designing method according to the present invention is directed to design a wireless system having a mode in which an address is assigned to each wireless station when a network is formed. The wireless system designing method includes estimating the link quality between respective wireless stations installed within a predetermined region, and confirming whether or not an address can be assigned to each wireless station in a topology formed only with links which are estimated to present link qualities equal to or higher than a predetermined level.

A wireless system designing system according to the present invention is directed to design a wireless system having a mode in which an address is assigned to each wireless station when a network is formed. The wireless system designing system includes a first wireless system designing device including room arrangement data creating means for generating room arrangement data including data on an environment in a predetermined region in which a wireless system is installed, and data on locations at which wireless stations are installed in the wireless system; link quality determining means for determining the link quality between respective installed wireless stations; address assignment possibility determining means for determining whether or not an address can be assigned to each wireless station based on the determination result of the link quality determining means; and result display means for displaying the determination result of the link quality determining means and the determination result of the address assignment possibility determining means, and a second wireless system designing device including propagation estimation processing means for analyzing propagation of a wireless signal in the environment of the predetermined region in which the wireless system is installed, using the room arrangement data created by the room arrangement data creating means to generate data on the result of estimating radio wave propagation characteristics in the environment, wherein the link quality determining means determines the link quality between respective wireless stations based on the estimation result data generated by the propagation estimation processing means.

A wireless system designing system according to the present invention is directed to design a wireless system having a mode in which an address is assigned to each wireless station when a network is formed. The wireless system designing system includes a first wireless system designing device including room arrangement data creating means for generating room arrangement data including data on an environment in a predetermined region in which a wireless system is installed, and data on locations at which wireless stations are installed in the wireless system, and a second wireless system designing device including propagation estimation processing means for analyzing propagation of a wireless signal in the environment of the predetermined region in which the wireless system is installed, using the room arrangement data created by the room arrangement data creating means to generate data on the result of estimating radio wave propagation characteristics in the environment; link quality determining means for determining the link quality between respective wireless stations based on the estimation result data generated by the propagation estimation processing means; address assignment possibility determining means for determining whether or not an address can be assigned to each wireless station based on a determination result of the link quality determining means; and wireless station movement/addition processing means for performing at least either processing for moving an existing wireless station or processing for additionally installing a new wireless station when the address assignment possibility determining means determines that an address cannot be assigned to each wireless station.

A wireless system designing apparatus according to the present invention is directed to design a wireless system having a mode in which an address is assigned to each wireless station when a network is formed. The wireless system designing apparatus includes room arrangement data creating means for generating room arrangement data including data on an environment in a predetermined region in which a wireless system is installed, and data on locations at which wireless stations are installed in the wireless system, link quality determining means for determining the link quality between respective installed wireless stations, address assignment possibility determining means for determining whether or not an address can be assigned to each wireless station based on the determination result of the link quality determining means, and result display means for displaying the determination result of the link quality determining means and a determination result of the address assignment possibility determining means.

A wireless system designing apparatus according to the present invention is directed to design a wireless system having a mode in which an address is assigned to each wireless station when a network is formed. The wireless system designing apparatus includes propagation estimation processing means for analyzing propagation of a wireless signal in the environment of the predetermined region in which the wireless system is installed, to generate data on the result of estimating radio wave propagation characteristics in the environment, link quality determining means for determining the link quality between respective wireless stations based on the estimation result data generated by the propagation estimation processing means, address assignment possibility determining means for determining whether or not an address can be assigned to each wireless station based on the determination result of the link quality determining means, and wireless station movement/addition processing means for performing at least one processing procedure to moving an existing wireless station and additionally for performing at least either processing for moving an existing wireless station or processing for additionally installing a new wireless station when the address assignment possibility determining means determines that an address cannot be assigned to each wireless station.

A wireless system designing program according to the present invention causes a computer which implements a wireless system designing method for designing a wireless system having a mode in which an address is assigned to each wireless station when a network is formed, to execute quality estimation processing for estimating the link quality between respective wireless stations installed within a predetermined region, and confirmation processing for confirming whether or not an address can be assigned to each wireless station in a topology which is formed only with links which are estimated in the quality estimation processing to present link qualities equal to higher than a predetermined level.

### EFFECTS OF THE INVENTION

According to the present invention, a station placement design can be accomplished to ensure that addresses can be assigned when the station placement design is performed for a wireless system having a mode in which an address is assigned to each wireless station when a network is formed.

### BRIEF DESCRIPTION OF THE DRAWINGS

FIG. 1

A system configuration diagram showing an example of a wireless communication system conforming to the ZigBee standard specification.

FIG. 2

A system configuration diagram showing an example of a wireless system designing system according to the present invention.

FIG. 3

A flow chart showing a processing procedure for creating room arrangement data and uploading the data to a wireless system designing server device.

FIG. 4

An explanatory diagram showing an example of room arrangement data.

FIG. 5

An explanatory diagram showing an example of room arrangement data.

FIG. 6

A flow chart showing the operation of the wireless system designing server device when it generates estimation result data.

FIG. 7

A flow chart showing a processing procedure until the designing result at a wireless system designing client device is confirmed.

FIG. 8

An explanatory diagram showing an example in which received power is applied as a specific index of communication quality.

FIG. 9

An explanatory diagram showing an example of a processing result screen displayed by a result display unit.

FIG. 10

An explanatory diagram showing an example of a processing result screen displayed by the result display unit.

FIG. 11

An explanatory diagram showing an example of a processing result screen displayed by a result display unit.

FIG. 12

An explanatory diagram showing an example of a processing result screen displayed by a result display unit.

FIG. 13

A system configuration diagram showing an example of a wireless system designing system in a second exemplary embodiment.

FIG. 14

A flow chart showing processing executed by a wireless system designing server device.

FIG. 15

A block diagram showing an example of a wireless system designing apparatus in a third exemplary embodiment.

FIG. 16

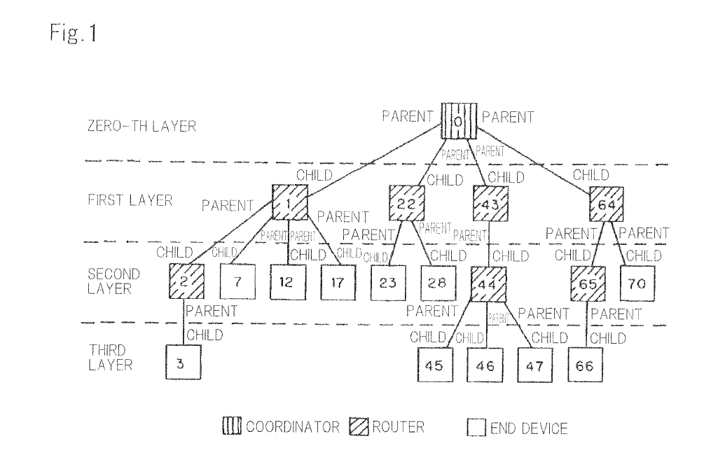

A block diagram showing an example of a station placement designing system in a fourth exemplary embodiment.

### DESCRIPTION OF REFERENCE NUMERALS

10 Wireless System Designing Client Device
20 Wireless System Designing Server Device
30 Network
40 Layout Data
50 Estimation Result Data
60 Layout Data Creation Unit
70 WWW Client Unit
80 WWW Server Unit
90, 91 Link Quality Determination Units
100, 101 Address Assignment Possibility Determination Units
110 Result Display Unit
120, 121 Communication Processing Units
130 Propagation Estimation Processing Unit
140 Wireless station Movement/Addition Processing Unit
150 Wireless System Designing Apparatus
160 General-Purpose Personal Computer

### BEST MODE FOR CARRYING OUT THE INVENTION

### Exemplary Embodiment 1

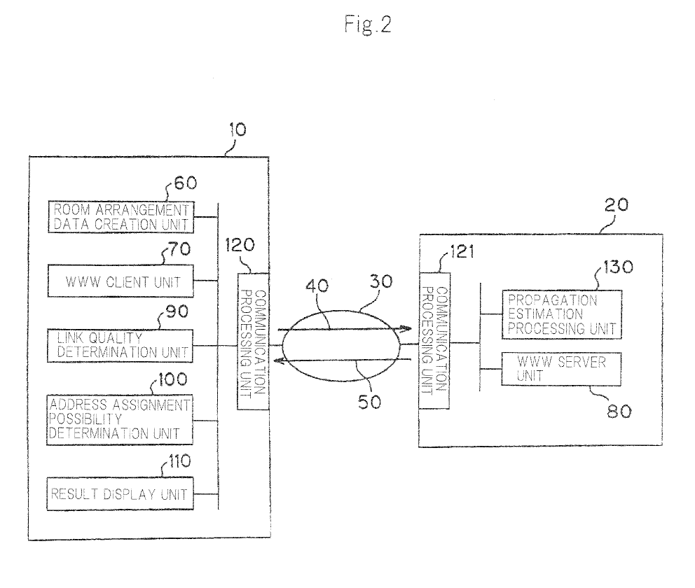

In the following, one exemplary embodiment of the present invention will be described with reference to the drawings. FIG. 2 is a system configuration diagram showing an exemplary embodiment of a wireless system designing system (ZigBee-specific station placement designing system) according to the present invention. In this system, wireless system designing client device 10 and wireless system designing server device 20 are connected through network 30.

Wireless system designing client device 10 has a function of generating room arrangement data, later described. Layout data 40 generated by wireless system designing client device 10 is uploaded to wireless system designing server device 20 through network 30.

Wireless system designing server device 20 has a function of generating estimation result data, later described. Specifically, wireless system designing server device 20 processes room arrangement data 40 uploaded by wireless system designing client device 10 to generate estimation result data 50. Generated estimation result data 50 is downloaded from wireless system designing server device 20 to wireless system designing client device 10 through network 30. Then, wireless system designing client device 10 processes estimation result data 50 to confirm a designing result.

Essentially, here, wireless system designing client device 10, wireless system designing server device 20, and network 30 may be owned by any one. Specifically, in one implementation, these may be collectively owned by one and the same person, or by a legal person. For example, this implementation applies to a system which is built within a proprietary intra-net by a legal person which owns all of the components.

Alternatively, all of them may be owned by different persons or legal persons in another implementation. For example, this implementation applies to a scenario where a legal person who owns wireless system designing server device 20 sells wireless system designing client device 10 to a client such that the client can access wireless system designing server device 20 through the Internet.

Further alternatively, in another implementation, wireless system designing client device 10 and wireless system designing server device 20 may be owned by the same person or legal person, while network 30 may be owned by a person or a legal person different from the former. For example, this implementation is applied to a scenario where a legal person who owns wireless system designing client device 10 and wireless system designing server device 20 rents wireless system designing client device 10 to a client, and this legal person sells clients a right to access wireless system designing server device 20 through the Internet.

Wireless system designing client device 10 includes room arrangement data creation unit 60, WWW client unit 70, communication processing unit 120, link quality determination unit 90, address assignment possibility determination unit 100, and result display unit 110.

Layout data creation unit 60 may be generally referred to as room arrangement data creating means.

Layout data creation unit 60 generates room arrangement data 40 from a variety of parameters entered by a user.

WWW client unit 70 and communication processing unit 120 are used in a processing procedure for uploading room arrangement data 40 to wireless system designing server device 20, and in a processing procedure for downloading estimation result data 50 from wireless system designing server device 20.

Link quality determination unit 90 may be generally referred to as link quality determining means.

Link quality determination unit 90 analyzes downloaded estimation result data to determine wireless link quality between wireless stations.

Address assignment possibility determination unit 100 may be generally referred to as address assignment possibility determining means.

Address assignment possibility determination unit 100 analyzes downloaded estimation result data to determine the possibility of assigning a ZigBee short address to each wireless station.

Result display unit 110 may be generally referred to as result display means.

Result display unit 110 displays at least a determination result by link quality determination unit 90 or a determination result by address assignment possibility determination unit 100.

Wireless system designing server device 20 in turn includes propagation estimation processing unit 130, WWW server unit 80, and communication processing unit 121.

Propagation estimation processing unit 130 may be generally referred to as propagation estimation processing means.

Propagation estimation processing unit 130 analyzes the propagation of wireless signals in a wireless system that is to be built, using room arrangement data 40, to generate estimation result data 50.

WWW server unit 80 and communication processing unit 121 are used in a processing procedure for uploading room arrangement data 40 from wireless system designing client device 10 and in a processing procedure for downloading estimation result data 500 to wireless system designing client device 10.

In this regard, wireless system designing client device 10 and wireless system designing server device 20 described above simply include components required to describe this exemplary embodiment, but may include, for example, other components, not described.

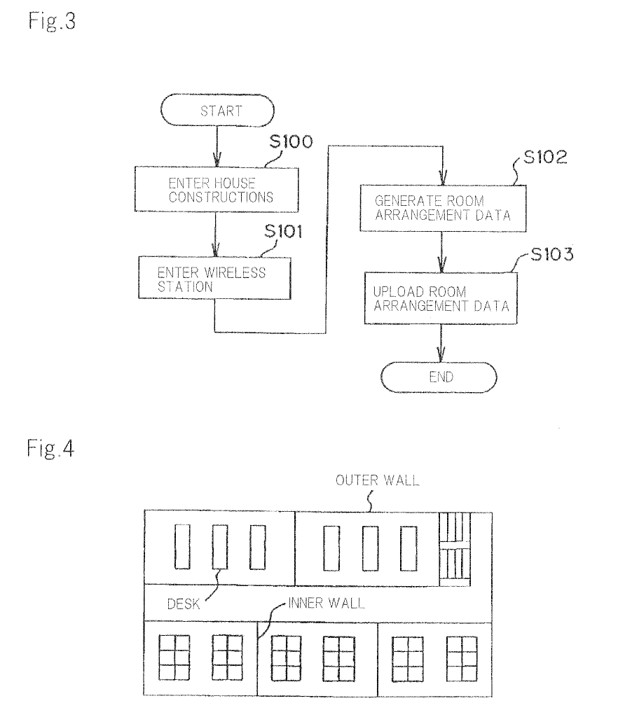

Next, a description will be given of a processing procedure performed by wireless system designing client device 10 to generate room arrangement data 40 and to upload this room arrangement data 40 to wireless system designing server device 20, with reference to the drawings. FIG. 3 is a flow chart showing the processing procedure performed by wireless system designing client device 10 to create the room arrangement data and to upload the room arrangement data to wireless system designing server device 20.

First, a user enters information on a house building (environment data) in an area in which a ZigBee system is to be built (predetermined area) into room arrangement data creation unit 60 (step S100). Here, the user enters information on house constructions such as walls, ceilings, floors, doors, windows and the like, as well as information on articles of furniture such as desks, partitions, cabinets and the like. More specifically, the information entered by the user includes dimensions, installed locations, materials and the like of the house building.

The installed locations may be entered as two-dimensional information or three-dimensional information, depending on the radiowave propagation estimation scheme performed by wireless system designing server device 20 (later described). Information on material, in turn, may be entered as metal, wood and the like, or entered as physical constants such as the dielectric coefficient and conductivity of materials.

In this regard, the user may employ a graphical user interface (GUI) as the aforementioned information entering scheme. Alternatively, the user may enter the information in the form of a numerical value array based on a predetermined format. As the processing at step S100 is completed, room arrangement data creation unit 60 generates data as shown in FIG. 4.

Then, the user enters information on wireless stations into room arrangement data creation unit 60 (step S101). The information entered here is information on a location at which a wireless station is installed. The location of an installed wireless station may be entered as two-dimensional information or entered as three-dimensional information depending on the radiowave propagation estimation scheme, as is the case with the aforementioned information on house constructions. As processing at step S101 is completed, room arrangement data creation unit 60 generates data as shown in FIG. 5. In this regard, the number given to each wireless station (for example, 1-6 in FIG. 5) is an identifier assigned to each wireless station for convenience in this processing procedure.

Next, room arrangement data creation unit 60 generates room arrangement data which includes the entered house construction information and wireless station information (step S102). WWW client unit 70 and communication processing unit 120 upload the room arrangement data created by room arrangement data creation unit 60 to wireless system designing server device 20 (step S103).

Additionally, In processing at step S101, the user may collectively enter information on attributes of a wireless station (information as to whether the wireless station is a coordinator, a router, or an end device) in addition to the information on the location of the installed wireless station. Also, the user may enter those parameters (Cm, Rm, Lm) together that are related to the short address assignment for the ZigBee system that is to be built. Further, the user may enter wireless parameter information together such as transmission power, antenna characteristics, wireless channels and the like.

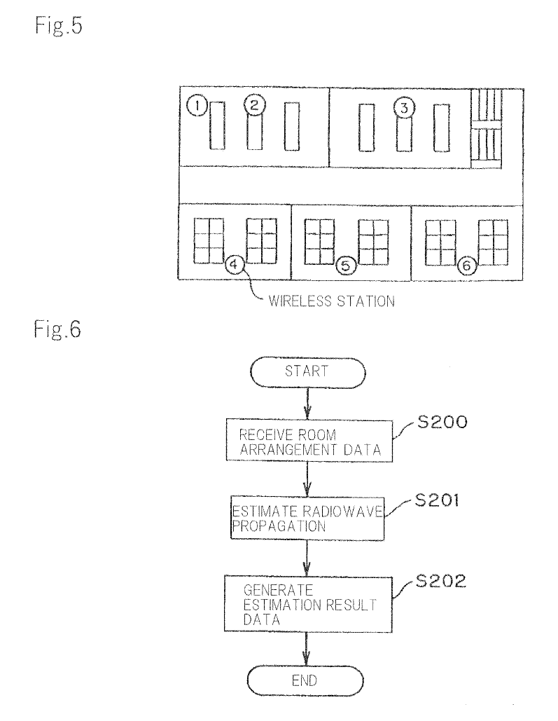

Next, a description will be given of a processing procedure up to the generation of estimation result data. FIG. 6 is a flow chart showing the operation of wireless system designing server device 20 when it generates estimation result data 50. First, WWW server unit 80 and communication processing unit 121 receive room arrangement data 40 in response to upload processing by wireless system designing client device 10 (step S200).

Next, propagation estimation processing unit 130 performs radiowave propagation estimation processing using received room arrangement data 40 (step S201). Here, propagation estimation processing unit 130 estimates how a wireless signal transmitted from a wireless station propagates in a space of the constructions of house contained in room arrangement data 40. Specifically, propagation estimation processing unit 130 estimates radiowave propagation characteristics. While radiowave propagation estimation schemes are classified, for example, into a statistical estimation scheme and a deterministic estimation scheme, the radiowave propagation estimation scheme is not particularly limited in this exemplary embodiment and in each exemplary embodiment shown below. This exemplary embodiment applies a ray launching method which is one of deterministic estimation schemes. Finally, propagation estimation processing unit 130 preserves a radiowave propagation estimation result as estimation result data 50 (step S202), and terminates the processing.

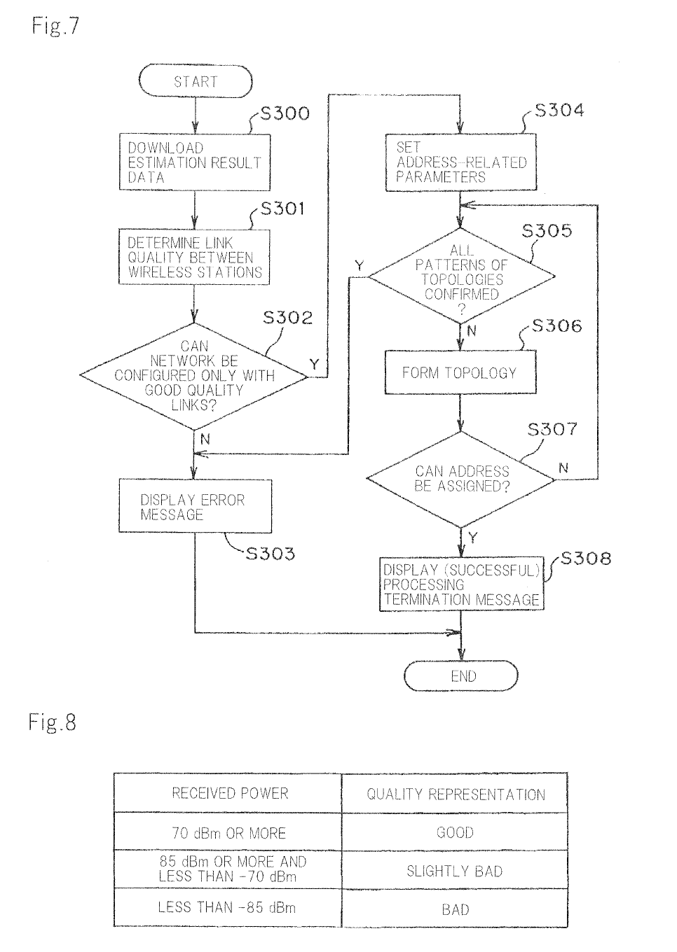

Next, a description will be given of a procedure for confirming a wireless system designing result. FIG. 7 is a flow chart showing a processing procedure until wireless system designing client device 10 confirms a design result. First, WWW client unit 70 and communication processing unit 120 download estimation result data 50 from wireless system designing server device 20 (step S300).

Then, link quality determination unit 90 determines the link quality between wireless stations using estimation result data 50 (step S301). The link quality between wireless stations refers to the communication quality of a wireless communication which is made between two arbitrary wireless stations which are extracted from all wireless stations contained in room arrangement data 40. A specific index of communication quality may be represented using, for example, received power, delay dispersion, SN ratio, bit error ratio and the like, or a combination of a plurality of them. Essentially, in the wireless system designing methods according to this exemplary embodiment and each exemplary embodiment shown below, the index of communication quality is not limited. Also, as a method of representing the communication quality, the value of the aforementioned index may be directly used, or a value generated by converting the values of these indexes may be used.

For example, received power is applied as a specific index of communication quality, and is converted by the processing shown in FIG. 8 to provide a quality representation at three stages which is employed in this exemplary embodiment. Specifically, in this exemplary embodiment, the communication quality is represented as three stages, “good,” “slightly bad,” and “bad.”

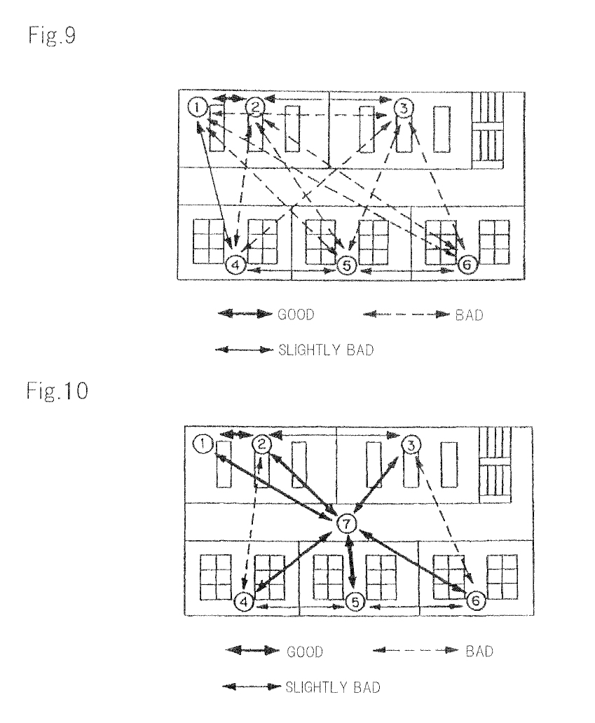

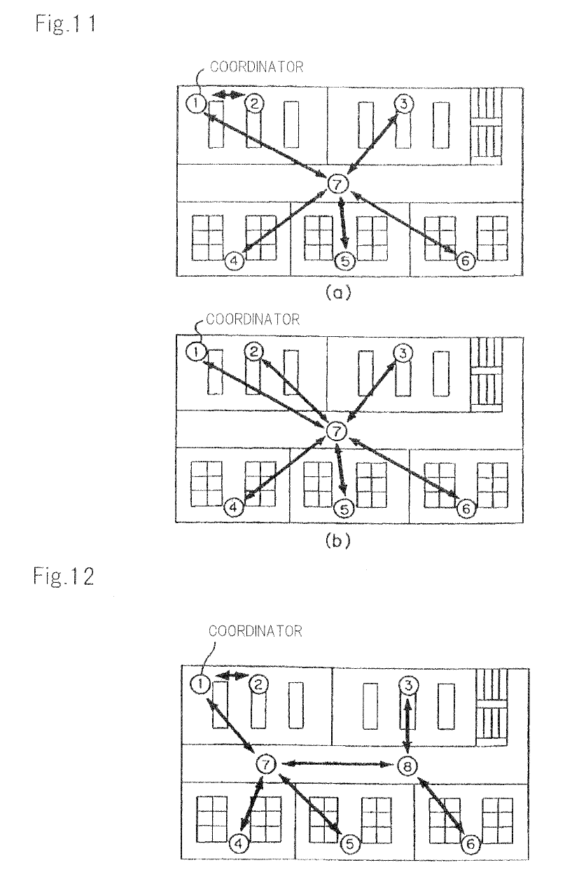

FIG. 9 is an explanatory diagram showing an example of a processing result screen displayed on result display unit 110. In this regard, result display unit 110 preferably displays at least information indicative of an environment in a predetermined area in which the wireless system is to be installed (environment data), information on locations within the environment at which wireless stations are installed (installed location data), and information indicative of the link quality between two wireless stations. In FIG. 9, the quality is represented at three stages in the form of an arrow in accordance with the convention which accompanies the figure. For example, FIG. 9 shows that the link (communication) quality is “good” between wireless station 1 and wireless station 2, whereas the link quality is “bad” between wireless station 3 and wireless station 5.

Subsequently, link quality determination unit 90 determines, with reference to the link quality determination result, whether or not a network can be configured only with links which provide a good communication quality (step S302). At this stage, no consideration is given as to the possibility of a short address assignment. For example, in the example in FIG. 9, since a “good” link quality is present only between wireless station 1 and wireless station 2, it can be seen that the network cannot be configured among wireless station 3-wireless station 6. Accordingly, in this event, the processing goes to step S303, where result display unit 110 displays that no network can be configured, followed by termination of the processing. In this regard, no network can be configured when there is one or more wireless stations which do not establish a link with any of the remaining wireless stations.

When an error message is generated in the processing shown in FIG. 7, the processing shown in FIG. 3 is performed again. For example, in the processing at step S101, wireless station 7 is newly added at a location as shown in FIG. 10. Then, room arrangement data creation unit 60 again generates room arrangement data which includes the entered house building information and wireless station information (step S102). WWW client unit 70 and communication processing unit 120 again upload room arrangement data 40 newly generated by room arrangement data creation unit 60 to wireless system designing server device 20 (step S103).

WWW server unit 80 and communication processing unit 121 receive room arrangement data 40 in response to upload processing by wireless system designing client device 10 (step S200). Then, propagation estimation processing unit 130 performs radiowave propagation estimation processing using received room arrangement data 40 (step S201), and preserves the radiowave propagation estimation result as estimation result data 50 (step S202).

WWW client unit 70 and communication processing unit 120 download estimation result data 50 from wireless system designing server device 20 (step S300). Then, link quality determination unit 90 determines the link quality between wireless stations using estimation result data 50 (step S301).

FIG. 11 is an explanatory diagram showing an example of a processing result screen displayed on result display unit 110. As shown in FIG. 11, as a result of determining the link quality by link quality determination unit 90, it is confirmed that a network that comprises of all wireless stations 1 through wireless station 7 can be configured only with links which have good communication qualities.

Next, the user sets parameters related to ZigBee short addresses (step S304). Specifically, the user sets three parameters (Cm, Rm, Lm) for determining address assignment, and the attribute (coordinator, router, end device) of each wireless station. In this regard, the former parameters (Cm, Rm, Lm) are all set to three in this exemplary embodiment. The latter attribute of the wireless stations, in turn, is set to a coordinator for wireless station 1, and to routers for all the wireless stations other than that.

In this regard, while the attribute is set as mentioned above in this exemplary embodiment, wireless stations, except for one coordinator, may be set to either a router or an end device.

After processing for setting the address related parameters, address assignment possibility determination unit 100 executes processing for determining the possibility of short address assignment (steps S305-S307). In this exemplary embodiment, the wireless system can take two types of topologies (implementations) shown in FIG. 11. Specifically, there are two patterns, i.e., a pattern (FIG. 11(a)) in which two wireless stations 2, 7 are connected as child stations of wireless station 1 which is a coordinator, and a pattern (FIG. 11(b)) in which wireless station 7 alone is connected as a child station of wireless station 1.

In the example shown in FIG. 11, there are two or one child station which is a router on the layer one stage below the coordinator, so that either of Cm and Rm can satisfy the condition (in this exemplary embodiment, Cm and Rm have been set to three). However, on the layer which is another stage below, there are four or five wireless stations which can be child stations of wireless station 7, the condition for Cm cannot be satisfied by either of the cases. In other words, in the case shown in FIG. 11, although the condition for the wireless link quality could be satisfied, there was no solution which could satisfy the condition for the possibility of address assignment (NO at step S307).

In this example, since all patterns of topology are confirmed, the processing goes to step S303. In this event, result display unit 110 displays an error message stating that addresses cannot be assigned, followed by termination of the processing.

When the error message is displayed in the processing in FIG. 7, the processing shown in FIG. 3 is again executed. For example, wireless station 8 is newly added in the processing at step S101. Then, room arrangement data creation unit 60 again generates room arrangement data which includes the entered house construction information and wireless station information (step S102). WWW client unit 70 and communication processing unit 120 again upload room arrangement data 40 newly created by room arrangement data creation unit 60 to wireless system designing server device 20 (step S103).

WWW server unit 80 and communication processing unit 121 receive room arrangement data 40 in response to upload processing by wireless system designing client device 10 (step S200). Then, propagation estimation processing unit 130 performs radiowave propagation estimation processing using received room arrangement data 40 (step S201), and preserves the radiowave propagation estimation result as estimation result data 50 (step S202).

WWW client unit 70 and communication processing unit 120 download estimation result data 50 from wireless system designing server device 20 (step S300). Then, link quality determination unit 90 determines the link quality between wireless stations using estimation result data 50 (step S301). As a result of determining the link quality by link quality determination unit 90, it is confirmed that a network that comprises all wireless stations 1 through wireless station 8 can be configured only with links which have good communication qualities.

Next, the user sets three parameters (Cm, Rm, Lm) for determining the address assignment, and the attribute (coordinator, router, end device) of each wireless station. In this regard, the former parameters (Cm, Rm, Lm) are all set to three in this exemplary embodiment. The latter attribute of the wireless stations, in turn, is set to a coordinator for wireless station 1, and to a router for all the wireless stations other than that.

Address assignment possibility determination unit 100 executes processing for determining the possibility of short address assignment after processing for setting the address related parameters (steps S305-S307). Then, a wireless system which satisfies both the link quality and address assignment can be eventually designed by moving wireless station 7 and also additionally installing wireless station 8, as shown in FIG. 12.

In this exemplary embodiment, address assignment possibility determination unit 100 determines whether or not an address can be assigned to each wireless station in a topology which is formed only with links which are estimated to present a link quality equal to or higher than a predetermined level. Accordingly, a station placement design can be accomplished taking into consideration of whether or not addresses can be assigned.

Also, in this exemplary embodiment, link quality determination unit 90 determines whether or not a network can be configured only with links which are estimated to have a communication quality equal to or higher than a predetermined level. Address assignment possibility determination unit 100 determines whether or not an address can be assigned to each wireless station within a network, when link quality determination unit 90 determines that the network can be configured.

Consequently, it is possible to prevent a determination from being made as to whether or not an address can be assigned to a wireless station which cannot form part of a network.

As described above, in this exemplary embodiment, a station placement design can be achieved taking into consideration of whether or not addresses can be assigned.

### Exemplary Embodiment 2

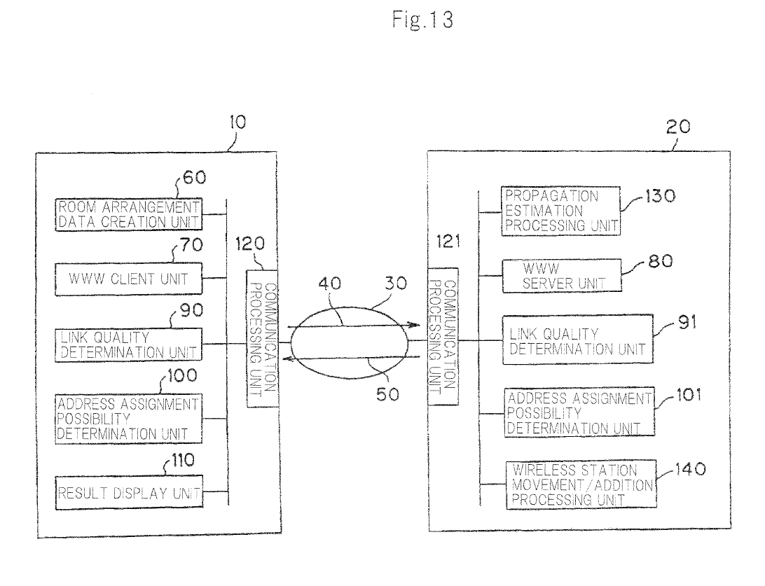

Next, a second exemplary embodiment of the present invention will be described with reference to the drawings. In this exemplary embodiment, wireless system designing server device 20 includes an automatic station placement design function. FIG. 13 is a system configuration diagram showing an example of a station placement designing system (wireless system designing system) in this exemplary embodiment. The station placement designing system of this exemplary embodiment includes wireless system designing client device 10, wireless system designing server device 20, and network 30. In this regard, wireless system designing client device 10 and network 30 have the same functions as wireless system designing client device 10 and network 30 in the first exemplary embodiment. Wireless system designing server device 20 further includes link quality determination unit 91, address assignment possibility determination unit 101, and wireless station movement/addition processing unit 140 in addition to the components provided in the wireless system designing server device in the first exemplary embodiment.

Link quality determination unit 91 may be generally referred to as link quality determining means. Link quality determination unit 91 determines the link quality between respective wireless stations based on estimation result data generated by propagation estimation processing unit 130.

Address assignment possibility determining means 101 may be generally referred to as address assignment possibility determining means. Address assignment possibility determination unit 101 determines whether or not an address can be assigned to each wireless station based on the determination result of link quality determination unit 91.

Wireless station movement/addition processing unit 140 may be generally referred to as wireless station movement/addition processing means. Wireless station movement/addition processing unit 140 performs at least one processing procedure for moving an existing wireless station and at least either processing for moving an existing wireless station or processing for additionally installing a new wireless station when address assignment possibility determination unit 101 determines that an address cannot be assigned to each wireless station.

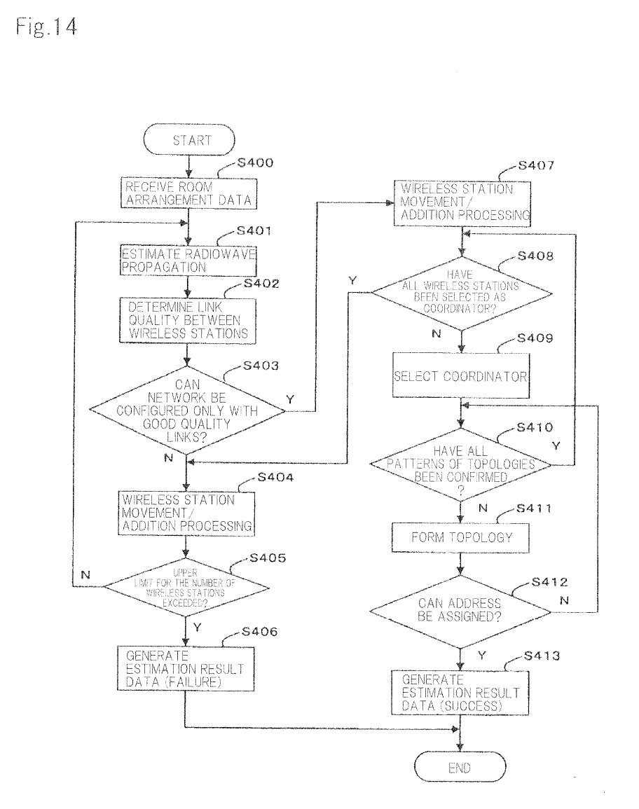

Next, a method of designing a wireless system will be described. FIG. 14 is a flow chart showing processing executed by wireless system designing server device 20.

First, a user enters information on a house building in an area in which a ZigBee system is to be built into room arrangement data creation unit 60 (step S100). Next, the user enters information on wireless stations (step S101). Layout data creation unit 60 generates room arrangement data which includes the entered house construction information and wireless station information (step S102). The room arrangement data created by room arrangement data creation unit 60 is uploaded by WWW client unit 70 and communication processing unit 120 to wireless system designing server device 20 (step S103).

As the room arrangement data is uploaded, WWW server 80 and communication processing unit 121 receive room arrangement data 40 uploaded by wireless system designing client device 10 (step S400). Then, propagation estimation processing unit 130 performs radiowave propagation estimation processing for received room arrangement data 40 (step S401). Radiowave propagation estimation result calculated by propagation estimation processing unit 130 is preserved as estimation result data 50.

Next, link quality determination unit 91 of wireless system designing server device 20 determines the link quality between wireless stations using estimation result data 50 (step S402). The link quality between wireless stations refers to the communication quality of a wireless communication which is made between two arbitrary wireless stations which are extracted from all wireless stations contained in room arrangement data 40.

Link quality determination unit 91 determines whether or not a network can be configured only with links which present good communication qualities, based on the determination result at step S402 (step S403). When a network can be configured, address assignment possibility determination unit 101 sets address related parameters (step S407).

Specifically, address assignment possibility determination unit 101 sets three parameters (Cm, Rm, Lm) for determining the address assignment. Notably, address assignment possibility determination unit 101 does not set an attribute of each wireless station in the processing at step S407.

Next, address assignment possibility determination unit 101 checks whether or not a topology can be configured to enable the address assignment (step S408). If no topology can be configured to enable the address assignment (NO at step S408), address assignment possibility determination unit 101 selects one wireless station as a coordinator (step S409). In this event, address assignment possibility determination unit 101 sets an attribute of each wireless station. Then, address assignment possibility determination unit 101 checks whether or not addresses can be assigned in any of the topologies in which the selected wireless station is designated as a coordinator (steps S410-S412).

When a topology which enables the address assignment is found, the processing goes from step S412 to step S413. Specifically, estimation result data is generated (step S413), followed by termination of the processing.

When any pattern which enables the address assignment is not found even after all topologies have been checked, the processing goes from step S410 to step S408. Specifically, address assignment possibility determination unit 101 determines whether or not all wireless stations have been selected as a coordinator. When all wireless stations have not been selected as a coordinator, address assignment possibility determination unit 101 selects a different wireless station as a coordinator (step S409).

When all wireless stations have been selected as a coordinator, the processing goes from step S408 to step S404. Additionally, the processing also goes to step S404 when link quality determination unit 91 determines that no network can be configured with links which have good link qualities (NO at step S403).

When the processing goes to step S404, wireless station movement/addition processing unit 140 performs processing to move an existing wireless station, or processing to add a new wireless station. In the following, a description will be given of an example of specific contents in the processing at step S404.

To move a previously installed wireless station, wireless station movement/addition processing unit 140 first notices a certain wireless station which has a slightly bad link quality between this wireless station and another wireless station. Then, wireless station movement/addition processing unit 140 moves the wireless station such that the propagation distance becomes shorter, in order to improve the link quality between these wireless stations. In this regard, when a wireless station has established links with a plurality of wireless stations, wireless station movement/addition processing unit 140 moves the wireless station with attention given to maintaining those links which have good communication qualities. Wireless station movement/addition processing unit 140 determines the moving distance based on the relationship between the distance between wireless stations and the radiowave propagation loss.

To add a new wireless station, wireless station movement/addition processing unit 140 first notices a link which has slightly bad link quality between a certain wireless station and another wireless station, and a link which has a bad communication quality. Then, wireless station movement/addition processing unit 140 adds/installs a wireless station for relay at an intermediate location between these wireless stations.

As the processing is completed at step S404, wireless station movement/addition processing unit 140 determines whether or not the number of installed wireless stations exceeds an upper limit for the number of wireless stations to which addresses can be assigned (step S405).

For example, when all the three parameters (Cm, Rm, Lm) for determining the address assignment have the value of three, addresses can be assigned only to 40 wireless stations in total, including a coordinator. Accordingly, in this event, wireless station movement/addition processing unit 140 confirms whether or not the number of installed wireless stations exceeds 40 (step S405). When the number of installed wireless stations does not exceed 40 (NO at step S405), propagation estimation processing unit 130 again performs radiowave propagation estimation processing (step S401). When the number of installed wireless stations exceeds 40 (YES at step S405), wireless station movement/addition processing unit 140 generates estimation result data indicative of a failure, and terminates the processing (step S406).

WWW client unit 70 and communication processing unit 120 of wireless system designing client device 10 download estimation result data 50 from wireless system designing server device 20. Then, result display unit 110 displays a message which indicates whether or not a wireless system can be designed, followed by termination of the processing.

According to this exemplary embodiment, wireless station movement/addition processing unit 140 performs at least either processing for moving an existing wireless station or processing for additionally installing a new wireless station when it is confirmed that addresses cannot be assigned to one or more wireless stations in all topologies which are formed only with those links which are estimated to have link qualities equal to or higher than a predetermined level.

Also, wireless station movement/addition processing 140 performs at least either processing for moving an existing wireless station or processing for additionally installing a new wireless station when it is confirmed that no network can be configured only with those links which are estimated to have link qualities equal to or higher than a predetermined level.

Also, wireless station movement/addition processing unit 140 determines whether or not the number of installed wireless stations exceeds the number of wireless stations to which addresses can be assigned after it has executed a modification.

Thus, the station placement design processing can be automatically executed to alleviate a burden on the user.

As described above, in this exemplary embodiment, since wireless system designing server device 20 automatically executes the station placement design processing, a wireless system can be readily designed taking into consideration whether or not addresses can be assigned.

### Exemplary Embodiment 3

Next, a third exemplary embodiment of the present invention will be described with reference to the drawings. As shown in FIGS. 2 and 13, in the first exemplary embodiment and second exemplary embodiment, a system applied therein includes wireless system designing client device 10 and wireless system designing server device 20 which are connected with each other through network 30. The station placement design processing in this exemplary embodiment is executed solely by wireless system designing apparatus 150 which is equipped with functions of both of a client device and a server device.

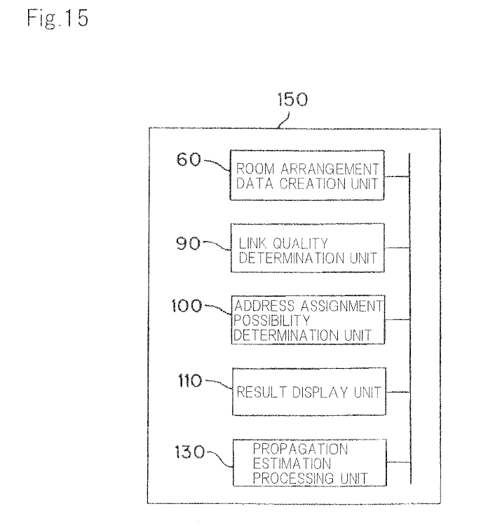

FIG. 15 is a block diagram showing an example of wireless system designing apparatus 150 in the third exemplary embodiment. Wireless system designing apparatus 150 includes components in the processing blocks provided in wireless system designing client device 10 and wireless system designing server device 20 shown in FIG. 2, except for processing blocks which are required to transmit/receive data between a client and a server.

Specifically, wireless system designing apparatus 150 includes room arrangement data creation unit 60, link quality determination unit 90, address assignment possibility determination unit 100, result display unit 110, and propagation estimation processing unit 130. Essentially, wireless system designing apparatus 150 may be implemented by components in the processing blocks provided in wireless system designing client device 10 and wireless system designing server device 20 shown in FIG. 13, except for processing blocks which are required to transmit/receive data between a client and a server. With such a configuration, the user can perform a station placement design for a wireless system solely with wireless system designing apparatus 150.

### Exemplary Embodiment 4

Next, a fourth exemplary embodiment of the present invention will be described with reference to the drawings. As shown in FIGS. 2 and 13, in the first exemplary embodiment and second exemplary embodiment, a system applied therein includes wireless system designing client device 10 and wireless system designing server device 20 which are connected with each other through network 30. In this exemplary embodiment, general-purpose personal computer 160 is used as a wireless system designing client device.

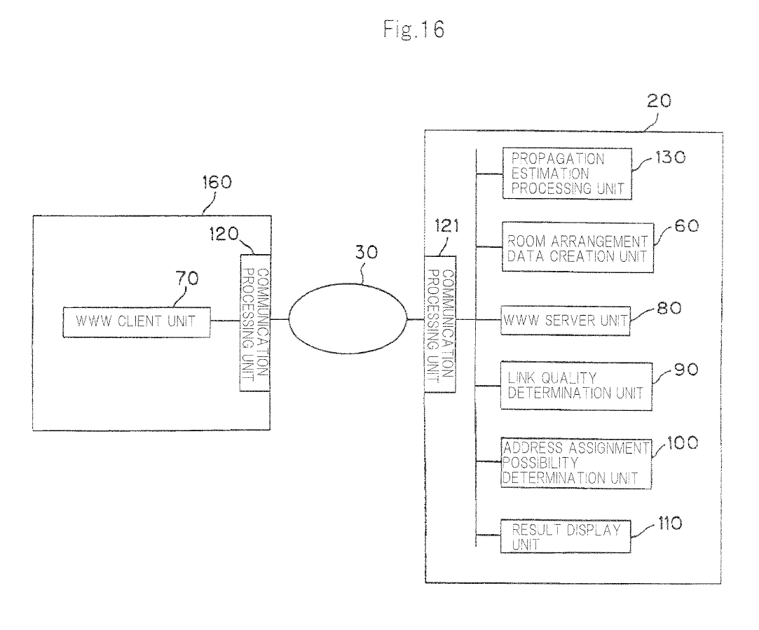

FIG. 16 is a block diagram showing an example of a station placement designing system (wireless system designing system). As shown in FIG. 16, the station placement system is implemented by connecting general-purpose personal computer 160 and wireless system designing server device 20 through network 30. In this event, wireless system designing server device 20 is implemented by providing a processing unit particular to wireless designing, provided in wireless system designing client device 10 in FIG. 2.

Specifically, wireless system designing server device 20 includes room arrangement data creation unit 60, link quality determination unit 90, address assignment possibility determination unit 100, and result display unit 110, in addition to propagation estimation processing unit 130, WWW server unit 80, and communication processing unit 121. By doing so, the client (user) side can perform a station placement design for a wireless system by utilizing general-purpose personal computer 160 which includes WWW client unit 70 and communication processing unit 120.

As described above, according to each of the exemplary embodiments described above, a station placement design can be carried out taking into consideration whether or not addresses can be assigned, when the station placement design is performed for a wireless system of the type which assigns an address to each wireless station when a network is configured.

In this regard, in each of the exemplary embodiments described above, wireless system designing client device 10, wireless system designing server device 20, and wireless system designing apparatus 150 may be formed by a computer which operates based on a program.

In this event, a computer corresponding to wireless system designing client device 10 functions, for example, as room arrangement data creation unit 60, link quality determination unit 90, address assignment possibility determination unit 100, and result display unit 110 by executing a program recorded on a recording medium.

Also, a computer corresponding to wireless system designing server device 20 functions, for example, as propagation estimation processing unit 130, link quality determination unit 91, address assignment possibility determination unit 101, and wireless station movement/addition processing unit 140 by executing a program recorded on a recording medium.

Also, a computer corresponding to wireless system designing apparatus 150 functions, for example, as room arrangement data creation unit 60, propagation estimation processing unit 130, link quality determination unit 90, address assignment possibility determination unit 100, and result display unit 110 by executing a program recorded on a recording medium.

A wireless system designing method according to a fifth exemplary embodiment of the present invention preferably includes a modification step of performing at least either processing for moving an existing wireless station or processing for additionally installing a new wireless station when it is confirmed at a confirmation step that addresses cannot be assigned to one or more wireless stations in all topologies which are formed only with links which are estimated to have qualities equal to or higher than a predetermined level.

In a wireless system designing method according to a sixth exemplary embodiment of the present invention, it is determined at the confirmation step whether or not a network can be configured only with links which are estimated to have qualities equal to or higher than a predetermined level, and it is confirmed whether or not an address can be assigned to each wireless station in a network which is determined to be configurable.

Also, a wireless system designing method according to a seventh exemplary embodiment of the present invention may include a modification step of for performing at least either processing for moving an existing wireless station or processing for additionally installing a new wireless station, when it is confirmed at the confirmation step that no network can be configured only with links which are estimated to have qualities equal to or higher than the predetermined level.

Also, a wireless system designing method according to an eighth exemplary embodiment of the present invention may include a determination step of determining whether or not the number of installed wireless stations exceeds the number of wireless stations to which addresses can be assigned after executing the modification step.

Also, a wireless system designing method according to a ninth exemplary embodiment of the present invention may be directed to a wireless system based on the ZigBee standard.

A wireless system designing method according to a tenth exemplary embodiment of the present invention is characterized by executing, in a station placement design, the steps of estimating the link quality between wireless stations, and confirming whether or not addresses can be assigned in a topology which is formed only with links which have good qualities.

In a wireless system designing system according to an eleventh exemplary embodiment of the present invention, a wireless system is preferably a wireless system according to the ZigBee standard.

A wireless system designing system according to a twelfth exemplary embodiment of the present invention is a wireless system designing system for assigning an address to each wireless station when a network is configured, characterized by including a first wireless system designing device comprising a room arrangement data creation unit for generating room arrangement data including data on an environment in which a wireless system is installed, and data on locations at which wireless stations are installed for configuring the wireless system; a link quality determination unit for determining the communication quality of a wireless link formed between respective wireless stations; an address assignment possibility determination unit for determining the possibility of assigning an address to each wireless station; and a result display unit for displaying at least the determination result of the link quality determination unit or a determination result of the address assignment possibility determination unit, and a second wireless system designing device comprising a propagation estimation processing unit for analyzing propagation of a wireless signal between respective wireless stations using the room arrangement data created by the room arrangement data creation unit of the first wireless system designing device to generate data on the result of estimating a communication quality between respective wireless stations.

Also, a wireless system designing system according to a thirteenth exemplary embodiment of the present invention is a wireless system designing system for assigning an address to each wireless station when a network is configured, characterized by including a first wireless system designing device comprising a room arrangement data creation unit for generating room arrangement data including data on an environment in which a wireless system is installed, and data on locations at which wireless stations are installed for configuring the wireless system; a link quality determination unit for determining the communication quality of a wireless link formed between respective wireless stations; an address assignment possibility determination unit for determining the possibility of assigning an address to each wireless station; and a result display unit for displaying at least a determination result of the link quality determination unit or a determination result of the address assignment possibility determination unit, and a second wireless system designing device comprising a propagation estimation processing unit for analyzing propagation of a wireless signal between respective wireless stations using the room arrangement data created by the room arrangement data creation unit of the first wireless system designing device to generate data on the result of estimating a communication quality between respective wireless stations; a link quality determination unit for determining the communication quality of a wireless link formed between respective wireless stations; an address assignment possibility determination unit for determining the possibility of assigning an address to each wireless station; and a wireless station movement/addition processing unit for performing processing to move an existing wireless station or adding a new wireless station.

A wireless system designing apparatus according to a fourteenth exemplary embodiment of the present invention includes a result display unit for displaying at least information indicative of an environment in which a wireless system is installed, information indicative of locations at which wireless stations are installed in that environment, and information indicative of the link quality between two wireless stations.

Also, a wireless system designed by a wireless system designing apparatus according to a fifteenth exemplary embodiment of the present invention is preferably a wireless system based on the ZigBee standard.

A wireless system designing program according to a sixteenth exemplary embodiment of the present invention may cause a computer to execute modification processing for performing at least either processing for moving an existing wireless station or processing for additionally installing a new wireless station when it is confirmed by confirmation processing that addresses cannot be assigned to one or more wireless stations in all topologies which are formed only with links which are estimated to have qualities equal to or higher than a predetermined level.

Also, a wireless system designing program according to a seventeenth exemplary embodiment of the present invention preferably causes a computer to execute processing for determining whether or not a network can be configured only with links which are estimated to have a quality equal to or higher than a predetermined level, and confirming whether or not an address can be assigned to each wireless station in a network which is determined to be configurable, in the confirmation processing.

Also, a wireless system designing program according to an eighteenth exemplary embodiment of the present invention may cause a computer to execute modification processing for performing at least either processing for moving an existing wireless station or processing for additionally installing a new wireless station when it is confirmed in confirmation processing that no network can be configured only with links which are estimated to present qualities equal to or higher than the predetermined level.

It is an object of the present invention to provide a wireless system designing method, a wireless system designing system, a wireless system designing apparatus, and a wireless system designing program which are capable of designing a station placement for a wireless communication system which is required to ensure that addresses can be assigned in the station placement design.

### INDUSTRIAL AVAILABILITY

The foregoing exemplary embodiments can be applied to building a wireless communication system.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application claims the priority based on Japanese Patent Application No. 2006-313777 filed Nov. 21, 2006, the disclosure of which is herein incorporated by reference in its entirety.

1-17. (canceled)

18. A wireless system designing method for designing a wireless system having a mode in which an address is assigned to each wireless station when a network is formed, comprising:
estimating a link quality between respective wireless stations installed within a predetermined region; and
confirming whether or not an address can be assigned to each wireless station in a topology formed with links which are estimated to have link qualities equal to or higher than a predetermined level.

19. The wireless system designing method according to claim 18, further comprising:
modifying the placement of the wireless stations by performing at least either processing for moving an existing wireless station or processing for additionally installing a new wireless station when it is confirmed that addresses cannot be assigned to one or more wireless stations in a topology formed with links which are estimated to have link qualities equal to or higher than the predetermined level.

20. The wireless system designing method according to claim 19, wherein said modifying includes modifying the placement of the wireless stations by performing at least either processing for moving an existing wireless station or processing for additionally installing a new wireless station when it is confirmed that addresses cannot be assigned to one or more wireless stations in all topologies which are formed with links which are estimated to have link qualities equal to or higher than the predetermined level.

21. The wireless system designing method according to claim 18, wherein said confirming includes determining whether or not a network can be configured with links which are estimated to have link qualities equal to or higher than a predetermined level, and confirming whether or not an address can be assigned to each wireless station in the network which is determined to be configurable.

22. The wireless system designing method according to claim 21, further comprising:
modifying the placement of wireless stations by performing at least either processing for moving an existing wireless station or processing for additionally installing a new wireless station when it is confirmed that no network can be configured with links which are estimated to have link qualities equal to or higher than a predetermined level.

23. The wireless system designing method according to claim 18, wherein said confirming includes confirming whether or not an address can be assigned to each wireless station in a topology which is formed only with links which are estimated to have link qualities equal to or higher than the predetermined level.

24. The wireless system designing method according to claim 23, further comprising:
modifying the placement of the wireless stations by performing at least either processing for moving an existing wireless station or processing for additionally installing a new wireless station when it is confirmed that addresses cannot be assigned to one or more wireless stations in a topology which is formed only with links which are estimated to have link qualities equal to or higher than the predetermined level.

25. The wireless system designing method according to claim 24, wherein:
said modifying includes modifying the placement of the wireless stations by performing at least either processing for moving an existing wireless station or processing for additionally installing a new wireless station when it is confirmed that addresses cannot be assigned to one or more wireless stations in all topologies which are formed only with links which are estimated to have link qualities equal to or higher than the predetermined level.

26. The wireless system designing method according to claim 23, wherein said confirming includes determining whether or not a network can be configured only with links which are estimated to have link qualities equal to or higher than a predetermined level, and confirming whether or not an address can be assigned to each wireless station in the network which is determined to be configurable.

27. The wireless system designing method according to claim 26, further comprising:
modifying the placement of wireless stations by performing at least either processing for moving an existing wireless station or processing for additionally installing a new wireless station when it is confirmed that no network can be configured only with links which are estimated to present link qualities equal to or higher than a predetermined level.

28. The wireless system designing method according to claim 19, further comprising:
determining whether or not the number of installed wireless stations exceeds the number of wireless stations to which addresses can be assigned after executing said modification.

29. The wireless system designing method according to claim 18, wherein said method is directed to a wireless system based on the ZigBee standard.

30. A wireless system designing system for designing a wireless system having a mode in which an address is assigned to each wireless station when a network is formed, comprising:
a first wireless system designing device including:
a room arrangement data creating unit which generates room arrangement data including data on an environment in a predetermined region in which a wireless system is installed, and data on locations at which wireless stations are installed in the wireless system;
a link quality determining unit which determines link quality between respective installed wireless stations;
an address assignment possibility determining unit which determines whether or not an address can be assigned to each wireless station based on a determination result of said link quality determining unit; and
a result display unit which displays the determination result of said link quality determining unit and a determination result of said address assignment possibility determining unit; and
a second wireless system designing device including a propagation estimation processing unit which analyzes propagation of a wireless signal in the environment of the predetermined region in which the wireless system is installed, using the room arrangement data created by said room arrangement data creating unit to generate data on the result of estimating radio wave propagation characteristics in the environment,
wherein said link quality determining unit determines link quality between respective wireless stations based on the estimation result data generated by said propagation estimation processing unit.

31. A wireless system designing system for designing a wireless system having a mode in which an address is assigned to each wireless station when a network is formed, comprising:
a first wireless system designing device including a room arrangement data creating unit which generates room arrangement data including data on an environment in a predetermined region in which a wireless system is installed, and data on locations at which wireless stations are installed in the wireless system; and
a second wireless system designing device including:
a propagation estimation processing unit which analyzes propagation of a wireless signal in the environment of the predetermined region in which the wireless system is installed, using the room arrangement data created by said room arrangement data creating unit to generate data on the result of estimating radio wave propagation characteristics in the environment;
a link quality determining unit which determines link quality between respective wireless stations based on the estimation result data generated by said propagation estimation processing unit;
an address assignment possibility determining unit which determines whether or not an address can be assigned to each wireless station based on a determination result of said link quality determining unit; and
a wireless station movement/addition processing unit which performs at least either processing for moving an existing wireless station or processing for additionally installing a new wireless station when said address assignment possibility determining unit determines that an address cannot be assigned to each wireless station.

32. The wireless system designing system according to claim 30, wherein said wireless system is a wireless system based on the ZigBee standard.

33. A wireless system designing apparatus for designing a wireless system having a mode in which an address is assigned to each wireless station when a network is formed, comprising:
a room arrangement data creating unit which generates room arrangement data including data on an environment in a predetermined region in which a wireless system is installed, and data on locations at which wireless stations are installed in the wireless system;
a link quality determining unit which determines link quality between respective installed wireless stations;
an address assignment possibility determining unit which determines whether or not an address can be assigned to each wireless station based on a determination result of said link quality determining unit; and
a result display unit which displays the determination result of said link quality determining unit and a determination result of said address assignment possibility determining unit.

34. The wireless system designing apparatus according to claim 33, wherein:
said result display unit displays at least information indicative of the environment in the predetermined region in which the wireless system is installed, information indicative of the locations at which the wireless stations are installed in the environment, and information indicative of link quality between two wireless stations.

35. A wireless system designing apparatus for designing a wireless system having a mode in which an address is assigned to each wireless station when a network is formed, comprising:
a propagation estimation processing unit which analyzes propagation of a wireless signal in an environment of a predetermined region in which the wireless system is installed, to generate data on the result of estimating radio wave propagation characteristics in the environment;
a link quality determining unit which determines link quality between respective wireless stations based on the estimation result data generated by said propagation estimation processing unit;
an address assignment possibility determining unit which determines whether or not an address can be assigned to each wireless station based on a determination result of said link quality determining unit; and
a wireless station movement/addition processing unit which performs at least either processing for moving an existing wireless station or processing for additionally installing a new wireless station when said address assignment possibility determining unit determines that an address cannot be assigned to each wireless station.

36. The wireless system designing apparatus according to claim 33, wherein:
said wireless system is a wireless system based on the ZigBee standard.

37. A wireless system designing program for causing a computer which implements a wireless system designing method for designing a wireless system having a mode in which an address is assigned to each wireless station when a network is formed, to execute:
quality estimation processing for estimating link quality between respective wireless stations installed within a predetermined region; and
confirmation processing for confirming whether or not an address can be assigned to each wireless station in a topology which is formed with links which are estimated in said quality estimation processing to have link qualities equal to higher than a predetermined level.

38. The wireless system designing program according to claim 37, for further causing said computer to execute:
modification processing for performing at least either processing for moving an existing wireless station or processing for additionally installing a new wireless station when it is confirmed that address cannot be assigned to one or more wireless stations in a topology which is formed with links which are estimated to have link qualities equal to or higher than the predetermined level.

39. The wireless system designing program according to claim 38, for further causing said computer to execute:
processing for performing at least either processing for moving an existing wireless station or processing for additionally installing a new wireless station in said modification processing when it is confirmed that addresses cannot be assigned to one or more wireless stations in all topologies which are formed with links which are estimated to have link qualities equal to or higher than the predetermined level.

40. The wireless system designing program according to claim 37, for causing said computer to execute processing for determining whether or not a network can be configured with links which are estimated to have link qualities equal to or higher than a predetermined level, and confirming whether or not an address can be assigned to each wireless station in the network which is determined to be configurable in said confirmation processing.

41. The wireless system designing program according to claim 40, for further causing said computer to execute:
modification processing for performing at least either processing for moving an existing wireless station or processing for additionally installing a new wireless station when it is confirmed that no network can be configured with links which are estimated to have link qualities equal to or higher than a predetermined level.

42. The wireless system designing program according to claim 37, for further causing said computer to execute:
processing for confirming whether or not an address can be assigned to each wireless station in a topology which formed only with links which are estimated to have link qualities equal to or higher than a predetermined level in said confirmation processing.

43. The wireless system designing program according to claim 42, for further causing said computer to execute:
modification processing for performing at least either processing for moving an existing wireless station or processing for additionally installing a new wireless station when it is confirmed that addresses cannot be assigned to one or more wireless stations in a topology which is formed only with links which are estimated to have link qualities equal to or higher than the predetermined level.

44. The wireless system designing program according to claim 43, for causing said computer to execute:
processing for performing at least either processing for moving an existing wireless station or processing for additionally installing a new wireless station in said modification processing, when it is confirmed that addresses cannot be assigned to one or more wireless stations in all topologies which are formed only with links which are estimated to have link qualities equal to or higher than the predetermined level.

45. The wireless system designing program according to claim 42, for causing said computer to execute:
processing for determining whether or not a network can be configured only with links which are estimated to have link qualities equal to or higher than a predetermined level, and confirming whether or not an address can be assigned to each wireless station in the network which is determined to be configurable in said confirmation processing.

46. The wireless system designing program according to claim 45, for further causing said computer to execute:
modification processing for performing at least either processing for moving an existing wireless station or processing for additionally installing a new wireless station when it is confirmed that no network can be configured only with links which are estimated to have link qualities equal to or higher than a predetermined level.

47. A wireless system designing system for designing a wireless system having a mode in which an address is assigned to each wireless station when a network is formed, comprising:
a first wireless system designing device including:
room arrangement data creating means for generating room arrangement data including data on an environment in a predetermined region in which a wireless system is installed, and data on locations at which wireless stations are installed in the wireless system;
link quality determining means for determining link quality between respective installed wireless stations;
address assignment possibility determining means for determining whether or not an address can be assigned to each wireless station based on a determination result of said link quality determining means; and
result display means for displaying the determination result of said link quality determining means and a determination result of said address assignment possibility determining means; and
a second wireless system designing device including propagation estimation processing means for analyzing propagation of a wireless signal in the environment of the predetermined region in which the wireless system is installed, using the room arrangement data created by said room arrangement data creating means to generate data on the result of estimating radio wave propagation characteristics in the environment,
wherein said link quality determining means determines link quality between respective wireless stations based on the estimation result data generated by said propagation estimation processing means.

48. A wireless system designing system for designing a wireless system having a mode in which an address is assigned to each wireless station when a network is formed, comprising:
a first wireless system designing device including room arrangement data creating means for generating room arrangement data including data on an environment in a predetermined region in which a wireless system is installed, and data on locations at which wireless stations are installed in the wireless system; and
a second wireless system designing device including:
propagation estimation processing means for analyzing propagation of a wireless signal in the environment of the predetermined region in which the wireless system is installed, using the room arrangement data created by said room arrangement data creating means to generate data on the result of estimating radio wave propagation characteristics in the environment;
link quality determining means for determining link quality between respective wireless stations based on the estimation result data generated by said propagation estimation processing means;
address assignment possibility determining means for determining whether or not an address can be assigned to each wireless station based on a determination result of said link quality determining means; and
wireless station movement/addition processing means for performing at least either processing for moving an existing wireless station or processing for additionally installing a new wireless station when said address assignment possibility determining means determines that an address cannot be assigned to each wireless station.

49. A wireless system designing apparatus for designing a wireless system having a mode in which an address is assigned to each wireless station when a network is formed, comprising:
room arrangement data creating means for generating room arrangement data including data on an environment in a predetermined region in which a wireless system is installed, and data on locations at which wireless stations are installed in the wireless system;
link quality determining means for determining link quality between respective installed wireless stations;
address assignment possibility determining means for determining whether or not an address can be assigned to each wireless station based on a determination result of said link quality determining means; and
result display means for displaying the determination result of said link quality determining means and a determination result of said address assignment possibility determining means.

50. A wireless system designing apparatus for designing a wireless system having a mode in which an address is assigned to each wireless station when a network is formed, comprising:
propagation estimation processing means for analyzing propagation of a wireless signal in an environment of a predetermined region in which the wireless system is installed, to generate data on the result of estimating radio wave propagation characteristics in the environment;
link quality determining means for determining link quality between respective wireless stations based on the estimation result data generated by said propagation estimation processing means;
address assignment possibility determining means for determining whether or not an address can be assigned to each wireless station based on a determination result of said link quality determining means; and
wireless station movement/addition processing means for performing at least either processing for moving an existing wireless station or processing for additionally installing a new wireless station when said address assignment possibility determining means determines that an address cannot be assigned to each wireless station.
